(19) United States
(12) Patent Application Publication
(10) Pub. No.: US 2013/0301846 A1
(43) Pub. Date: Nov. 14, 2013

(54) FREQUENCY AND DIRECTION-DEPENDENT AMBIENT SOUND HANDLING IN PERSONAL AUDIO DEVICES HAVING ADAPTIVE NOISE CANCELLATION (ANC)

(71) Applicant: CIRRUS LOGIC, INC., Austin, TX (US)

(72) Inventors: Jeffrey Alderson, Austin, TX (US); Jon D. Hendrix, Wimberly, TX (US); Dayong Zhou, Austin, TX (US)

(73) Assignee: CIRRUS LOGIC, INC., Austin, TX (US)

(21) Appl. No.: 13/784,018

(22) Filed: Mar. 4, 2013

Related U.S. Application Data
(60) Provisional application No. 61/645,244, filed on May 10, 2012.

(51) Int. Cl. H04R 3/00

(52) U.S. Cl. CPC H04R 3/002
USPC 381/71.7

(57) ABSTRACT

A personal audio device, such as a wireless telephone, includes noise canceling circuit that adaptively generates an anti-noise signal from a reference microphone signal and injects the anti-noise signal into the speaker or other transducer output to cause cancellation of ambient audio sounds. An error microphone may also be provided proximate the speaker to measure the output of the transducer in order to control the adaptation of the anti-noise signal and to estimate an electro-acoustical path from the noise canceling circuit through the transducer. A processing circuit that performs the adaptive noise canceling (ANC) function also detects frequency-dependent characteristics in and/or direction of the ambient sounds and alters adaptation of the noise canceling circuit in response to the detection.

This U.S. Patent Application Claims priority under 35 U.S.C. 119(e) to U.S. Provisional Patent Application Ser. No. 61/645,244 filed on May 10, 2012.

### BACKGROUND OF THE INVENTION

1. Field of the Invention

The present invention relates generally to personal audio devices such as wireless telephones that include noise cancellation, and more specifically, to a personal audio device in which frequency or direction-dependent characteristics in the ambient sounds are detected and action is taken on the anti-noise signal in response thereto.

2. Background of the Invention

Wireless telephones, such as mobile/cellular telephones, cordless telephones, and other consumer audio devices, such as MP3 players and headphones or earbuds, are in widespread use. Performance of such devices with respect to intelligibility can be improved by providing noise canceling using a microphone to measure ambient acoustic events and then using signal processing to insert an anti-noise signal into the output of the device to cancel the ambient acoustic events.

Since the acoustic environment around personal audio devices such as wireless telephones can change dramatically, depending on the sources of noise that are present and the position of the device itself, it is desirable to adapt the noise canceling to take into account such environmental changes. However, adaptive noise canceling can be ineffective or may provide unexpected results for certain ambient sounds.

Therefore, it would be desirable to provide a personal audio device, including a wireless telephone, that provides effective noise cancellation in the presence of certain ambient sounds.

### SUMMARY OF THE INVENTION

The above-stated objective of providing a personal audio device providing noise cancellation in the presence of certain ambient sounds, is accomplished in a personal audio device, a method of operation, and an integrated circuit. The method is a method of operation of the personal audio device and the integrated circuit, which can be incorporated within the personal audio device.

The personal audio device includes a housing, with a transducer mounted on the housing for reproducing an audio signal that includes both source audio for playback to a listener and an anti-noise signal for countering the effects of ambient audio sounds in an acoustic output of the transducer. At least one microphone is mounted on the housing to provide a microphone signal indicative of the ambient audio sounds. The personal audio device further includes an adaptive noise-canceling (ANC) processing circuit within the housing for adaptively generating an anti-noise signal from the microphone signal such that the anti-noise signal causes substantial cancellation of the ambient audio sounds at a transducer. An error microphone may be included for controlling the adaptation of the anti-noise signal to cancel the ambient audio sounds and for compensating for the electro-acoustic path from the output of the processing circuit through the transducer. The ANC processing circuit detects ambient sounds having a frequency-dependent characteristic and takes action on the adaptation of the ANC circuit to avoid generating anti-noise that is disruptive, ineffective or that otherwise compromises performance.

In another aspect, the ANC processing circuit detects a direction of the ambient sounds, with or without detecting the frequency-dependent characteristic, and also takes action on adaptation of the ANC circuit to avoid generating anti-noise that is disruptive, ineffective or that otherwise compromises performance.

The foregoing and other objectives, features, and advantages of the invention will be apparent from the following, more particular, description of the preferred embodiment of the invention, as illustrated in the accompanying drawings.

### BRIEF DESCRIPTION OF THE DRAWINGS

FIG. 1 is an illustration of an exemplary wireless telephone 10.

FIG. 2 is a block diagram of circuits within wireless telephone 10.

FIGS. 3A-3C are block diagrams depicting signal processing circuits and functional blocks of various exemplary ANC circuits that can be used to implement ANC circuit 30 of CODEC integrated circuit 20 of FIG. 2.

FIG. 4 is a block diagram depicting a direction detection circuit that can be implemented within CODEC integrated circuit 20.

FIG. 5 is a signal waveform diagram illustrating operation of direction determining block 56.

FIG. 6 is a block diagram depicting signal processing circuits and functional blocks within CODEC integrated circuit 20.

### DESCRIPTION OF ILLUSTRATIVE EMBODIMENT

Noise canceling techniques and circuits that can be implemented in a personal audio device, such as a wireless telephone, are disclosed. The personal audio device includes an adaptive noise canceling (ANC) circuit that measures the ambient acoustic environment and generates a signal that is injected into the speaker (or other transducer) output to cancel ambient acoustic events. However, for some acoustic events or directionality, ordinary operation of the ANC circuit may lead to improper adaptation and erroneous operation. The exemplary personal audio devices, methods and circuits shown below detect ambient audio sounds having particular frequency characteristics or direction and take action on the adaptation of the ANC circuit to avoid undesirable operation. In particular, high frequency content, such as motor hiss in an automotive context, may not cancel well due to unknowns in the high-frequency response of the coupling between the transducer, the error microphone that measures the transducer output and the user's ear. Low frequency content, such as car noise rumble, is also not easily canceled below a certain frequency at which the transducer's ability to reproduce the anti-noise signal diminishes, and the frequency at which the low-frequency response diminishes depending on whether earphones or a built-in speaker of the wireless telephone is being used.

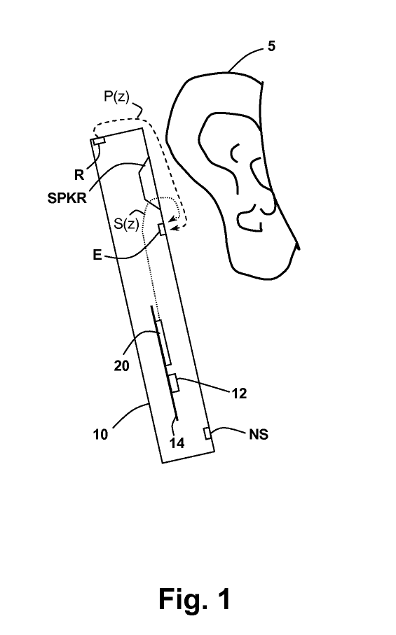

FIG. 1 shows an exemplary wireless telephone 10 in proximity to a human ear 5. Illustrated wireless telephone 10 is an example of a device in which techniques illustrated herein may be employed, but it is understood that not all of the elements or configurations embodied in illustrated wireless telephone 10, or in the circuits depicted in subsequent illustrations, are required. Wireless telephone 10 includes a transducer, such as speaker SPKR, that reproduces distant speech received by wireless telephone 10, along with other local audio events such as ringtones, stored audio program material, near-end speech, sources from web-pages or other network communications received by wireless telephone 10 and audio indications such as battery low and other system event notifications. A near-speech microphone NS is provided to capture near-end speech, which is transmitted from wireless telephone 10 to the other conversation participant(s).

Wireless telephone 10 includes adaptive noise canceling (ANC) circuits and features that inject an anti-noise signal into speaker SPKR to improve intelligibility of the distant speech and other audio reproduced by speaker SPKR. A reference microphone R is provided for measuring the ambient acoustic environment and is positioned away from the typical position of a user's/talker's mouth, so that the near-end speech is minimized in the signal produced by reference microphone R. A third microphone, error microphone E, is provided in order to further improve the ANC operation by providing a measure of the ambient audio combined with the audio signal reproduced by speaker SPKR close to ear 5, when wireless telephone 10 is in close proximity to ear 5. Exemplary circuit 14 within wireless telephone 10 includes an audio CODEC integrated circuit 20 that receives the signals from reference microphone R, near speech microphone NS, and error microphone E and interfaces with other integrated circuits such as an RF integrated circuit 12 containing the wireless telephone transceiver. In other embodiments of the invention, the circuits and techniques disclosed herein may be incorporated in a single integrated circuit that contains control circuits and other functionality for implementing the entirety of the personal audio device, such as an MP3 player-on-a-chip integrated circuit.

In general, the ANC techniques disclosed herein measure ambient acoustic events (as opposed to the output of speaker SPKR and/or the near-end speech) impinging on reference microphone R, and by also measuring the same ambient acoustic events impinging on error microphone E, the ANC processing circuits of illustrated wireless telephone 10 adapt an anti-noise signal generated from the output of reference microphone R to have a characteristic that minimizes the amplitude of the ambient acoustic events present at error microphone E. Since acoustic path P(z) extends from reference microphone R to error microphone E, the ANC circuits are essentially estimating acoustic path P(z) combined with removing effects of an electro-acoustic path S(z). Electro-acoustic path S(z) represents the response of the audio output circuits of CODEC IC 20 and the acoustic/electric transfer function of speaker SPKR including the coupling between speaker SPKR and error microphone E in the particular acoustic environment. Electro-acoustic path S(z) is affected by the proximity and structure of ear 5 and other physical objects and human head structures that may be in proximity to wireless telephone 10, when wireless telephone 10 is not firmly pressed to ear 5. While the illustrated wireless telephone 10 includes a two microphone ANC system with a third near speech microphone NS, other systems that do not include separate error and reference microphones can implement the above-described techniques. Alternatively, near speech microphone NS can be used to perform the function of the reference microphone R in the above-described system. Finally, in personal audio devices designed only for audio playback, near speech microphone NS will generally not be included, and the near-speech signal paths in the circuits described in further detail below can be omitted.

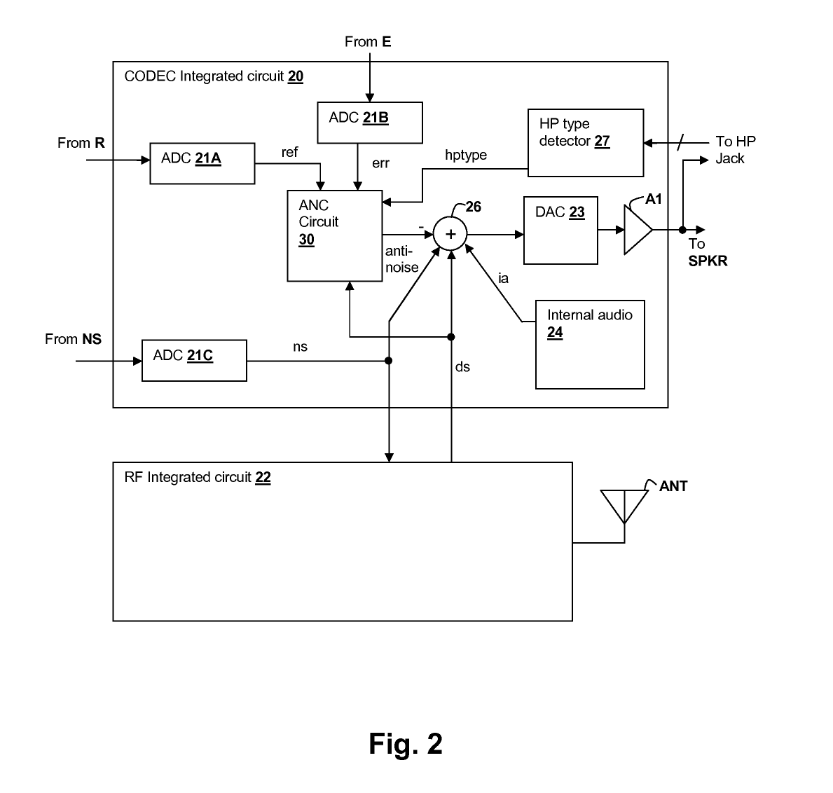

Referring now to FIG. 2, circuits within wireless telephone 10 are shown in a block diagram. CODEC integrated circuit 20 includes an analog-to-digital converter (ADC) 21A for receiving the reference microphone signal and generating a digital representation ref of the reference microphone signal, an ADC 21B for receiving the error microphone signal and generating a digital representation err of the error microphone signal, and an ADC 21C for receiving the near speech microphone signal and generating a digital representation of near speech microphone signal ns. CODEC IC 20 generates an output for driving speaker SPKR or headphones from an amplifier A1, which amplifies the output of a digital-to-analog converter (DAC) 23 that receives the output of a combiner 26. A headphone type detector 27 provides information via control signal hptype to ANC circuit 30 about whether a headset is connected, and optionally a type of the headset that is connected. Details of headset type detection techniques that may be used to implement headphone type detector 27 are disclosed in U.S. patent application Ser. No. 13/588,021 entitled “HEADSET TYPE DETECTION AND CONFIGURATION TECHNIQUES,” the disclosure of which is incorporated herein by reference. Combiner 26 combines audio signals ia from internal audio sources 24, the anti-noise signal anti-noise generated by ANC circuit 30, which by convention has the same polarity as the noise in reference microphone signal ref and is therefore subtracted by combiner 26. Additionally, combiner 26 also combines a portion of near speech signal ns so that the user of wireless telephone 10 hears their own voice in proper relation to downlink speech ds, which is received from radio frequency (RF) integrated circuit 22. In the exemplary circuit, downlink speech ds is provided to ANC circuit 30. The downlink speech ds and internal audio ia are provided to combiner 26 to provide source audio (ds+ia), so that source audio (ds+ia) may be presented to estimate acoustic path S(z) with a secondary path adaptive filter within ANC circuit 30. Near speech signal ns is also provided to RF integrated circuit 22 and is transmitted as uplink speech to the service provider via antenna ANT.

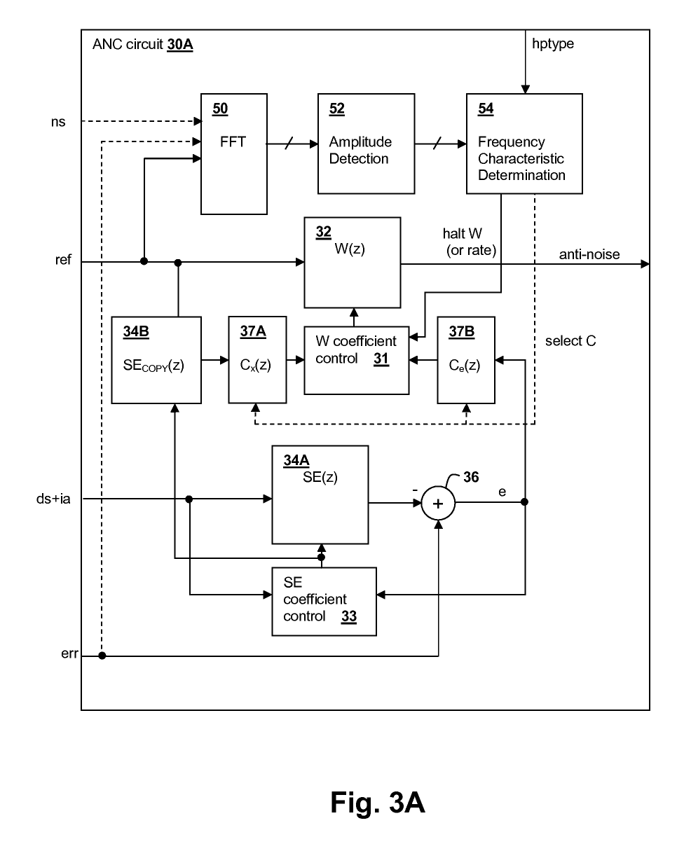

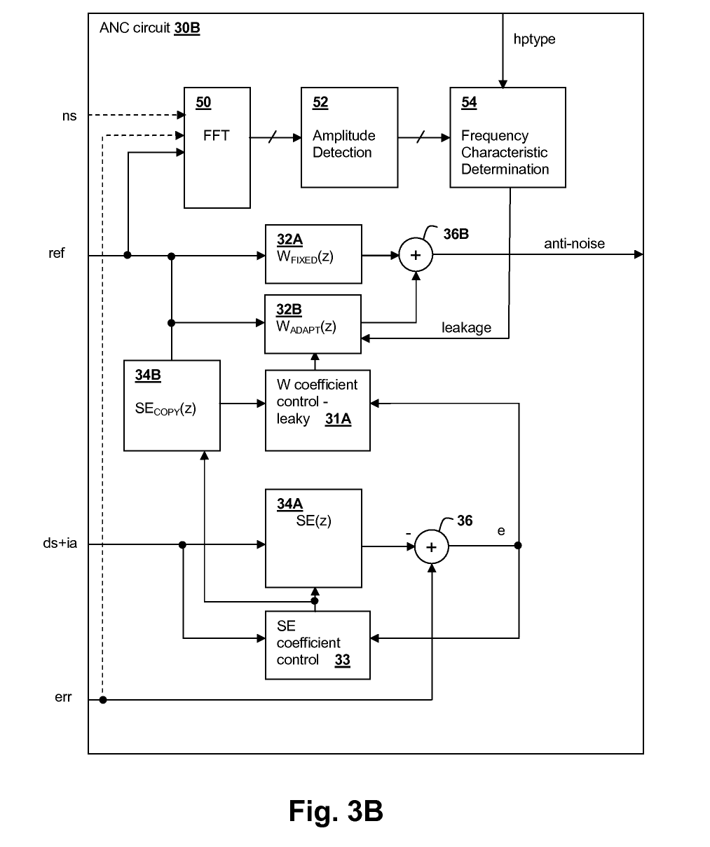

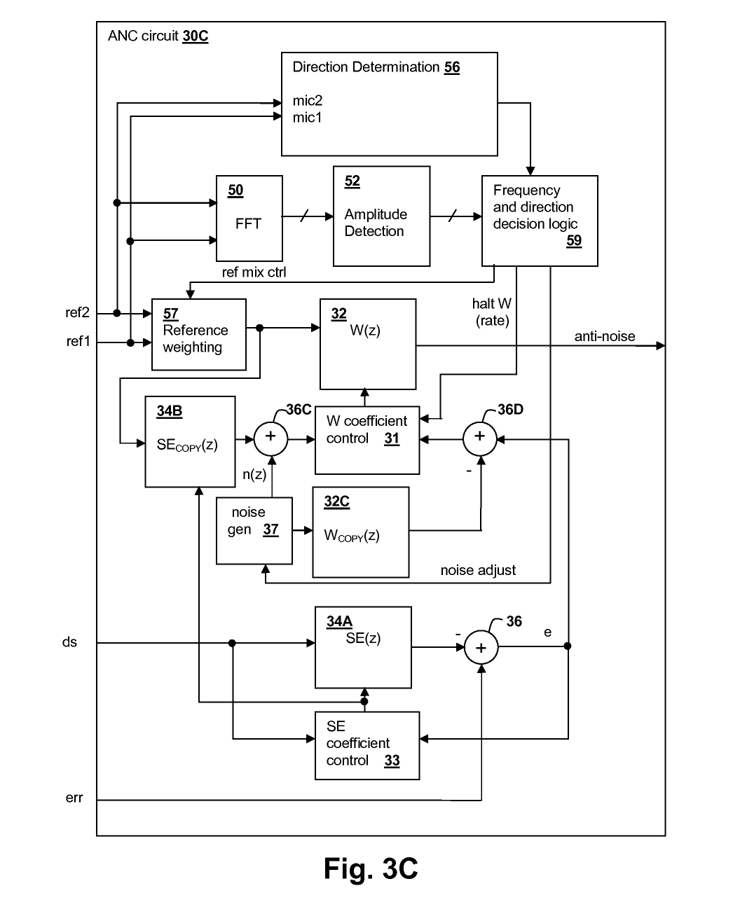

FIG. 3A shows one example of details of an ANC circuit 30A that can be used to implement ANC circuit 30 of FIG. 2. An adaptive filter 32 receives reference microphone signal ref and under ideal circumstances, adapts its transfer function W(z) to be P(z)/S(z) to generate anti-noise signal anti-noise, which is provided to an output combiner that combines the anti-noise signal with the audio signal to be reproduced by the transducer, as exemplified by combiner 26 of FIG. 2. The coefficients of adaptive filter 32 are controlled by a W coefficient control block 31 that uses a correlation of two signals to determine the response of adaptive filter 32, which generally minimizes the error, in a least-mean squares sense, between those components of reference microphone signal ref present in error microphone signal err. The signals processed by W coefficient control block 31 are the reference microphone signal ref as shaped by a copy of an estimate of the response of path S(z) provided by filter 34B and another signal that includes error microphone signal err. By transforming reference microphone signal ref with a copy of the estimate of the response of path S(z), response SE_{COPY}(z), and minimizing error microphone signal err after removing components of error microphone signal err due to playback of source audio, adaptive filter 32 adapts to the desired response of P(z)/S(z). A filter 37A, that has a response Cₓ(z) as explained in further detail below, processes the output of filter 34B and provides the first input to W coefficient control block 31. The second input to W coefficient control block 31 is processed by another filter 37B having a response of Cₑ(z). Response Cₑ(z) has a phase response matched to response Cₓ(z) of filter 37A. The input to filter 37B includes error microphone signal err and an inverted amount of downlink audio signal ds that has been processed by filter response SE(z), of which response SE_{COPY}(z) is a copy. Responses Cₑ(z) and Cₓ(z) are shaped to perform various functions. One of the functions of responses Cₑ(z) and Cₓ(z) is to remove low frequency components and offset that will cause improper operation and serve no purpose in the ANC system, as the response of the anti-noise signal is limited by the response of transducer SPKR. Another function of responses Cₑ(z) and Cₓ(z) is to bias the adaptation of the ANC system at higher frequencies where cancellation may or may not be effective depending on conditions.

In addition to error microphone signal err, the other signal processed along with the output of filter 34B by W coefficient control block 31 includes an inverted amount of the source audio (ds+ia) including downlink audio signal ds and internal audio ia that has been processed by filter response SE(z), of which response SE_{COPY}(z) is a copy. By injecting an inverted amount of source audio, adaptive filter 32 is prevented from adapting to the relatively large amount of source audio present in error microphone signal err. By transforming the inverted copy of downlink audio signal ds and internal audio ia with the estimate of the response of path S(z), the source audio that is removed from error microphone signal err before processing should match the expected version of source audio (ds+ia) present in error microphone signal err. The portion of source audio (ds+ia) that is removed matches the source audio (ds+ia) present in error microphone signal err because the electrical and acoustical path of S(z) is the path taken by downlink audio signal ds and internal audio ia to arrive at error microphone E. Filter 34B is not an adaptive filter, per se, but has an adjustable response that is tuned to match the response of adaptive filter 34A, so that the response of filter 34B tracks the adapting of adaptive filter 34A. To implement the above, adaptive filter 34A has coefficients controlled by SE coefficient control block 33, which processes the source audio (ds+ia) and error microphone signal err, after a combiner 36 removes the above-described filtered source audio (ds+ia) that has been filtered by adaptive filter 34A to represent the expected source audio delivered to error microphone E from error signal e. Adaptive filter 34A is thereby adapted to generate an error signal e from downlink audio signal ds and internal audio ia, that when subtracted from error microphone signal err, contains the content of error microphone signal err that is not due to source audio (ds+ia).

In order to avoid ineffective and generally disruptive ANC operation when the ambient audio sounds contain frequency-dependent characteristics that cannot be effectively canceled by ANC circuit 30A, ANC circuit 30A includes a fast-Fourier transform (FFT) block 50 that filters the reference microphone signal ref into a number of discrete frequency bins, and an amplitude detection block 52 that provides an indication of the energy of the reference microphone signal in each of the bins. The outputs of amplitude detection block 52 are provided to a frequency characteristic determination logic 54 that determines whether energy is present in one or more frequency bands of reference microphone signal ref in which ANC operation can be expected to be ineffective or cause erroneous adaptation or noise-cancellation. Which frequency bands are of interest may be programmable and may be selectable in response to various configurations of personal audio device 10. For example, different frequency bands may be selected depending on control signal hptype indicating what type of headset is connected to personal audio device 10, or ambient sound frequency characteristic detection might be disabled if a headset is connected. Depending on whether selected or predetermined frequency characteristics are present in reference microphone signal ref, frequency characteristic determination logic 54 takes action to prevent the improper adaptation/operation of the ANC circuit. Specifically, in the example given in FIG. 3A, frequency characteristic determination logic 54 halts operation of W coefficient control block 31 by asserting control signal halt W. Alternatively, or in combination control signal haltW may be replaced or supplemented with a rate control signal rate that lowers an update rate of W coefficient control block 31 when frequency characteristic determination logic 54 indicates that a particular frequency-dependent characteristic has been detected in the ambient sounds. As another alternative, frequency characteristic determination logic 54 may alter adaptation of response W(z) of adaptive filter 32 by selecting from among multiple responses for response Cₑ(z) of filter 37B and response Cₓ(z) of filter 37A, so that, depending on frequency dependent characteristics of the actual ambient signal received at reference microphone r, the responsiveness of coefficient control block 31 at particular frequencies can be changed, so that adaptation can be increased or decreased depending on the frequency content of the ambient sounds detected by ANC circuit 30A. While the illustrative example uses an analysis of only reference microphone signal ref to detect the frequency-dependent characteristics of the ambient sounds, near-speech microphone NS can be used, as long as actual near-speech conditions are properly handled, and alternatively error microphone E can be used under certain conditions or at frequencies for which the user's ear does not occlude the ambient sounds. Further, multiple microphones, including duplicate reference microphones, can be used to provide input to fast-Fourier transform (FFT) block 50, which alternatively may use other filtering/analysis techniques such as discrete-Fourier transform (DFT) or a parallel set of filters such as infinite-impulse response (IIR) band-pass filters.

Referring now to FIG. 3B, details of another ANC circuit 30B that may alternatively be used to implement ANC circuit 30 of FIG. 2. ANC circuit 30B is similar to ANC circuit 30A of FIG. 3A, so only differences between them will be described below. In ANC circuit 30B, rather than employing an adaptive filter to implement response W(z) in ANC circuit 30B, a fixed response W_{FIXED}(x) is provided by filter 32A and an adaptive portion of the response W_{ADAPT}(Z) is provided by adaptive filter 32B. The outputs of filters 32A and 32B are combined by combiner 36B to provide a total response that has a fixed and an adaptive portion. W coefficient control block 31A has a controllable leaky response, i.e., the response is time-variant such that the response tends over time to a flat frequency response or another predetermined initial frequency response, so that any erroneous adaptation is corrected by undoing the adaptation over time. In ANC circuit 30B, frequency characteristic determination logic 54 controls a level of leakage with a control signal leakage, which may have only two states, i.e. leakage enabled or disabled, or may have a value that controls a time constant or update rate of the leakage applied to restore W_{ADAPT}(z) to an initial response.

Referring now to FIG. 3C, details of another ANC circuit 30C are shown in accordance with another exemplary circuit that may be used to implement ANC circuit 30 of FIG. 2. ANC circuit 30C is similar to ANC circuit 30A of FIG. 3A, so only differences between them will be described below. ANC circuit 30C includes the frequency characteristic determining elements as in ANC circuit 30A of FIG. 3A and ANC circuit 30B of FIG. 3B, i.e., FFT block 50 and amplitude detection 52, but also includes a direction determination block 56 that estimates the direction from which the ambient sounds are arriving. A combined frequency and direction decision logic 59 generates control outputs that take action on the adaptation of response W(z) of adaptive filter 32, which may be control signal halt W or rate as illustrated that halts or changes the rate of update of the coefficients generated by W coefficient control block 31. Other outputs may additionally or alternatively control adaptation of response W(z) of adaptive filter 32 as in ANC circuit 30A of FIG. 3A and ANC circuit 30B, e.g., selecting response Cₑ(z) of filter 37B and response Cₓ(z) of filter 37A as in ANC circuit 30A, or adjusting leakage of response W(z) as in ANC circuit 30B. In order to measure the direction of the incoming ambient sounds, two microphones are needed, which may be provided by reference microphone R in combination with another microphone such as near-speech microphone NS or error microphone E. However, to avoid the problem of distinguishing actual near speech from ambient sounds, and the different response of error microphone E to the ambient environment when the personal audio device 10 is against the user's ear, it is useful to provide two reference microphones for generating two reference microphone signals ref1 and ref2 as illustrated as inputs to ANC circuit 30C in FIG. 3C. A reference weighting block 57 is controlled by a control signal ref mix ctrl provided by frequency and direction decision logic 59, which can improve performance of ANC circuit 30C by selecting between reference microphone signals ref1 and ref2 or combining them with different gains, to provide the best measure of the ambient sounds.

Additionally, FIG. 3C illustrates yet another technique for altering the adaptation of the response W(z) of adaptive filter 32, which may optionally be included within either ANC circuit 30A of FIG. 3A and ANC circuit 30B of FIG. 3B. Rather than adjusting leakage of response W(z) or adjusting the response of the inputs to W coefficient control block 31, ANC circuit 30C injects a noise signal n(z) using a noise generator 37 that is supplied to a copy W_{COPY}(z) of the response W(z) of adaptive filter 32 provided by an adaptive filter 32C. A combiner 36C adds noise signal noise(z) to the output of adaptive filter 34B that is provided to W coefficient control 31. Noise signal n(z), as shaped by filter 32C, is subtracted from the output of combiner 36 by a combiner 36D so that noise signal n(z) is asymmetrically added to the correlation inputs to W coefficient control 31, with the result that the response W(z) of adaptive filter 32 is biased by the completely correlated injection of noise signal n(z) to each correlation input to W coefficient control 31. Since the injected noise appears directly at the reference input to W coefficient control 31, does not appear in error microphone signal err, and only appears at the other input to W coefficient control 31 via the combining of the filtered noise at the output of filter 32C by combiner 36D, W coefficient control 31 will adapt response W(z) to attenuate the frequencies present in noise signal n(z). The content of noise signal n(z) does not appear in the anti-noise signal, but only appears in the response W(z) of adaptive filter 32 which will have amplitude decreases at the frequencies/bands in which noise signal n(z) has energy. Depending on the frequency content of, or direction of, the ambient sounds arriving at personal audio device 10, frequency and direction decision logic block 59 can alter control signal noise adjust to select the spectrum that is injected by noise generator 37.

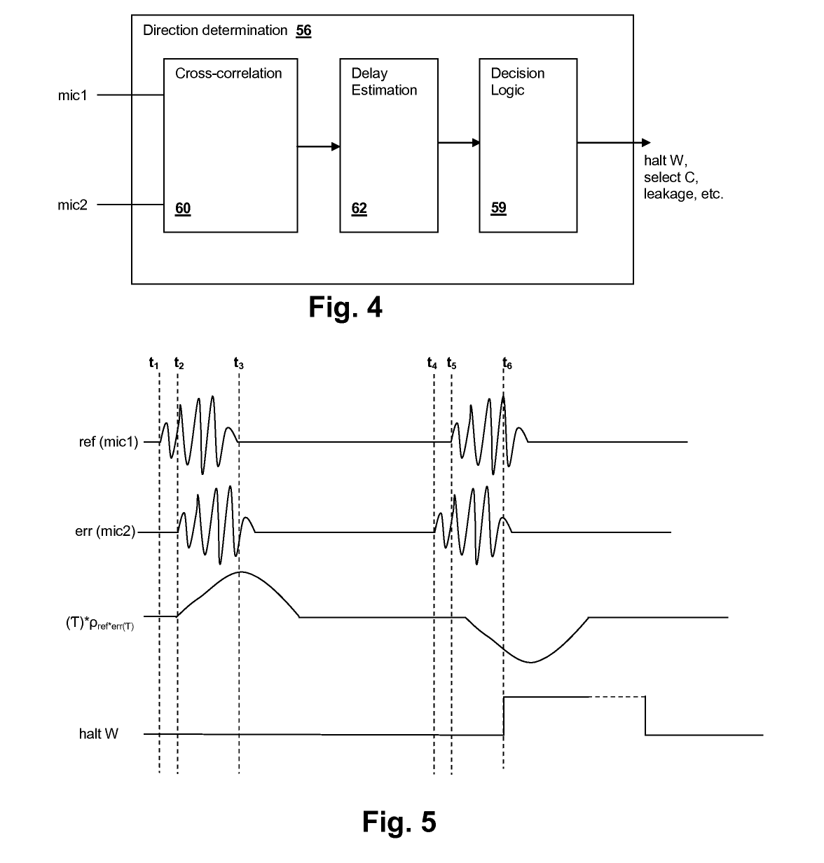

Referring now to FIG. 4, details of an exemplary direction determination block 56 of ANC circuit 30C are shown. Direction determination block 56 may also be used, alternatively with or in combination with, the frequency characteristic determining circuits in ANC circuit 30A or ANC circuit 30B. Direction determining block 56 determines information about direction of the ambient sounds by using two microphones, which may be a pair of reference microphones, or a combination of any two or more of reference microphone R, error microphone E and near-speech microphone NS. A cross-correlation is performed on the microphone signals, e.g., exemplary microphone signals mic1 and mic2, which may be outputs of any combination of the above microphones. The cross-correlation is used to compute a delay confidence factor, which is a waveform indicative of the delay between ambient sounds present in both microphone signals mic1 and mic2. The delay confidence factor is defined as (T)*ρ_{mic1*mic2}(T), where ρ_{mic1*mic2}(T) is the cross-correlation of microphone signals mic1 and mic2 and T=arg max_{T}[ρ_{mic1*mic2}(T)], which is the time at which the value of cross-correlation ρ_{mic1*mic2(T)} of microphone signals mic1 and mic2 is at a maximum. A delay estimation circuit 62 estimates the actual delay from the result of the cross-correlation function and decision logic block 59 determines whether or not to take action on the adaptation of the ANC circuits, depending on the direction of the detected ambient sounds. Decision logic block 59 may additionally receive inputs from frequency characteristic determination logic 54 of FIG. 3B so that a combination of frequency-dependent characteristics and directional information can be used to determine whether to take action such as halting W(z) adaptation, increasing leakage in the example of FIG. 3B, or selecting alternate responses for response Cₑ(z) of filter 37B and response Cₓ(z) of filter 37A, in the example of FIG. 3A.

Referring now to FIG. 5, a signal waveform diagram of signals within the circuit depicted in FIG. 4 is shown. At time t₁, an ambient sound has arrived at reference microphone R, and appears in reference microphone signal ref, which is an example of first microphone signal mic1. At time t₂, the same ambient sound has arrived at error microphone E, and appears in error microphone signal err, which is an example of second microphone signal mic2. The delay confidence factor (T)*ρ_{ref*err(T)} of the error microphone signal err and reference microphone signal ref is illustrated. The peak value of the delay confidence factor (T)*ρ_{ref*err(T)} at time t₃ is indicative of the delay between the arrival times at reference microphone R and error microphone E. Thus, for the first ambient sound arriving in the diagram of FIG. 5, the direction is toward the reference microphone, and therefore it could be expected that the ANC circuits could effectively cancel the ambient sound, barring any contrary indication from frequency characteristic determination logic 54 or another source of problem detection. However, the second ambient sound shown in FIG. 5 arrives at error microphone E at time t₄ and then at the reference microphone at time t₅, which indicates that the ambient sound is coming from the direction of error microphone E and possibly cannot be effectively canceled by the ANC system, in particular if the frequency content of the ambient sound is near the upper limit of ANC effectiveness. The direction is indicated in the reversed polarity of delay confidence factor (T)*ρ_{ref*err}(T). Therefore, at time t₆, when sufficient confidence that the ambient sound is coming from the direction of the transducer and error microphone E, rather than reference microphone R, decision logic 64 asserts control signal halt W to cease updating the coefficients of response W(z). Alternatively other actions such as increasing leakage or selecting different responses for Cₑ(z) of filter 37B and response Cₓ(z) of filter 37A could be performed in response to detecting such a condition. The examples illustrated in FIG. 4 and FIG. 5 are only illustrative, and in general, observation about repetitive or longer ambient sounds may be performed to effectively identify the direction of ambient sounds that may be problematic and require intervention in the ANC system. In particular, since processing and electro-acoustical path delays impact the ability of the ANC circuits to react to and cancel incoming ambient sounds, it is generally necessary to apply a criteria that if an ambient sound arrives at the reference microphone less than a predetermined period of time before arrival of the ambient sound at the error microphone, then the ANC circuit may determine not to alter ANC behavior in response to that condition.

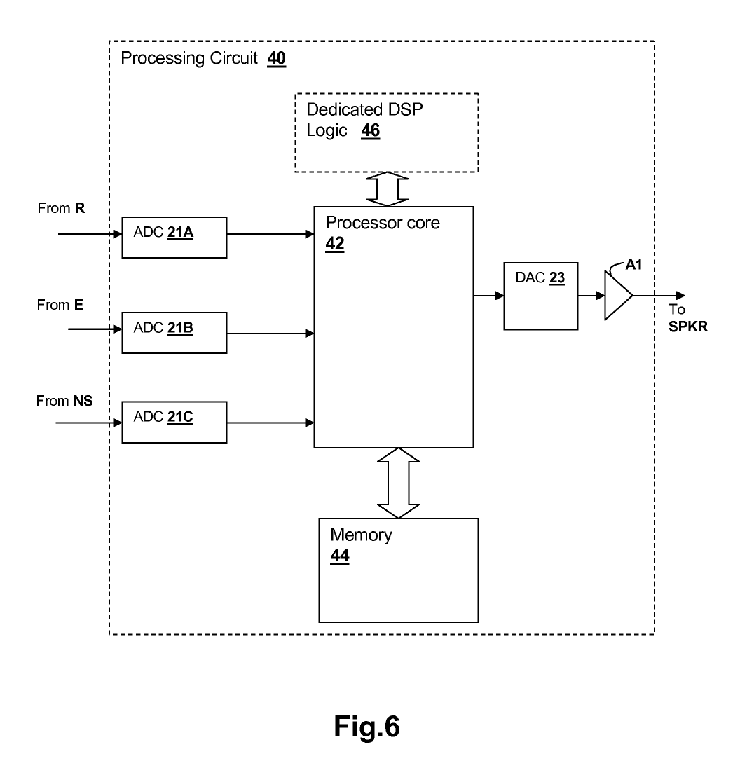

Referring now to FIG. 6, a block diagram of an ANC system is shown for implementing ANC techniques as depicted in FIG. 3, and having a processing circuit 40 as may be implemented within CODEC integrated circuit 20 of FIG. 2. Processing circuit 40 includes a processor core 42 coupled to a memory 44 in which are stored program instructions comprising a computer-program product that may implement some or all of the above-described ANC techniques, as well as other signal processing. Optionally, a dedicated digital signal processing (DSP) logic 46 may be provided to implement a portion of, or alternatively all of, the ANC signal processing provided by processing circuit 40. Processing circuit 40 also includes ADCs 21A-21C, for receiving inputs from reference microphone R, error microphone E and near speech microphone NS, respectively. DAC 23 and amplifier A1 are also provided by processing circuit 40 for providing the transducer output signal, including anti-noise as described above.

While the invention has been particularly shown and described with reference to the preferred embodiments thereof, it will be understood by those skilled in the art that the foregoing and other changes in form, and details may be made therein without departing from the spirit and scope of the invention.

What is claimed is:

1. A personal audio device, comprising:
a personal audio device housing;
a transducer mounted on the housing for reproducing an audio signal including both source audio for playback to a listener and an anti-noise signal for countering the effects of ambient audio sounds in an acoustic output of the transducer;
at least one microphone mounted on the housing for providing at least one microphone signal indicative of the ambient audio sounds; and
a processing circuit that generates the anti-noise signal to reduce the presence of the ambient audio sounds heard by the listener in conformity with the at least one microphone signal using an adaptive filter, wherein the processing circuit detects a frequency-dependent characteristic of one of the at least one microphone signal and alters adaptation of the adaptive filter in conformity with a result of the detection of the frequency-dependent characteristic.

2. The personal audio device of claim 1, wherein the at least one microphone signal includes a reference microphone signal, and wherein the processing circuit generates the anti-noise signal from the reference microphone signal by providing the reference microphone signal to an input of the adaptive filter, and wherein the processing circuit detects the frequency-dependent characteristic of the reference microphone signal.

3. The personal audio device of claim 1, wherein the at least one microphone signal includes a reference microphone signal, and wherein the processing circuit generates the anti-noise signal from the reference microphone signal by providing the reference microphone signal to an input of the adaptive filter, wherein the at least one microphone includes an error microphone mounted on the housing in proximity to the transducer for providing an error microphone signal indicative of the acoustic output of the transducer and the ambient audio sounds at the transducer, wherein the processing circuit further implements a secondary path filter having a secondary path response that shapes the source audio and a combiner that removes the source audio from the error microphone signal to provide an error signal indicative of the combined anti-noise and ambient audio sounds delivered to the listener, and wherein the adaptive filter generates the anti-noise signal in conformity with the error signal and the reference microphone signal.

4. The personal audio device of claim 3, wherein the processing circuit detects the frequency-dependent characteristic of the reference microphone signal.

5. The personal audio device of claim 3, wherein the processing circuit detects the frequency-dependent characteristic of the error microphone signal.

6. The personal audio device of claim 3, wherein the processing circuit further implements a non-adaptive filter having a fixed response for shaping inputs to a coefficient control block of the adaptive filter, so that sensitivity of the adaptation of the adaptive filter is altered at one or more frequencies or in one or more frequency bands by the fixed response, and wherein the altering of the adaptation of the adaptive filter is performed by altering the fixed response of the non-adaptive filter.

7. The personal audio device of claim 6, wherein the processing circuit selects the fixed response from among multiple predetermined frequency responses in conformity with a result of detecting the frequency-dependent characteristic of the at least one microphone signal.

8. The personal audio device of claim 1, wherein the processing circuit detects the frequency-dependent characteristic of one or both of the reference microphone signal and the error microphone signal.

9. The personal audio device of claim 8, wherein the processing circuit detects the frequency-dependent characteristic of both of the reference microphone signal and the error microphone signal and determines a direction of ambient audio sounds causing the frequency-dependent characteristic, and wherein the processing circuit alters adaptation of the adaptive filter selectively in conformity with the direction of the ambient audio sounds.

10. The personal audio device of claim 1, wherein the at least one microphone signal includes a near-speech microphone mounted on the housing for providing a near-speech microphone signal indicative of speech of the listener and the ambient audio sounds, wherein the processing circuit detects the frequency-dependent characteristic of the near-speech microphone signal.

11. The personal audio device of claim 1, wherein the processing circuit detects the frequency-dependent characteristic of the at least one microphone signal by measuring an amplitude of one or more frequencies or frequency bands of the at least one microphone signal.

12. The personal audio device of claim 11, wherein the one or more frequencies or frequency bands are selectable.

13. The personal audio device of claim 11, further comprising:
a headset connector for connecting an external headset; and
a headset type detection circuit for detecting a type of the external headset, and wherein the processing circuit selects the one or more frequencies or frequency bands in conformity with the detected type of the external headset.

14. The personal audio device of claim 1, wherein the processing circuit halts adaptation of the adaptive filter in response to detecting the frequency-dependent characteristic of the at least one microphone signal.

15. The personal audio device of claim 1, wherein the detecting detects whether low-frequency content is present.

16. The personal audio device of claim 1, wherein the detecting detects whether high-frequency content is present.

17. The personal audio device of claim 1, wherein the altering alters a rate of update of a coefficient control block of the adaptive filter.

18. The personal audio device of claim 1, wherein the processing circuit controls a variable portion of a frequency response of the adaptive filter with a leakage characteristic that restores the response of the adaptive filter to a predetermined response at a particular rate of change, and wherein the processing circuit alters the particular rate of change in conformity with a result of the detection of the frequency-dependent characteristic.

19. The personal audio device of claim 1, wherein the processing circuit alters adaptation of the response of the adaptive filter by altering a characteristic of a signal injected to shape a response of the adaptive filter.

20. A method of countering effects of ambient audio sounds by a personal audio device, the method comprising:
adaptively generating an anti-noise signal to reduce the presence of the ambient audio sounds heard by the listener in conformity with the at least one microphone signal using an adaptive filter;
combining the anti-noise signal with source audio;
providing a result of the combining to a transducer;
detecting a frequency-dependent characteristic of one of the at least one microphone signal; and
altering adaptation of the adaptive filter in conformity with a result of the detection of the frequency-dependent characteristic.

21. The method of claim 20, wherein the at least one microphone includes a reference microphone for measuring the ambient audio sounds, wherein the at least one microphone signal includes a reference microphone signal generated from an output of the reference microphone, wherein the method further comprises generating the anti-noise signal from the reference microphone signal by providing the reference microphone signal to an input of the adaptive filter, and wherein the detecting detects the frequency-dependent characteristic of the reference microphone signal.

22. The method of claim 20, wherein the at least one microphone includes a reference microphone for measuring the ambient audio sounds and an error microphone for measuring the ambient audio sounds and an acoustic output of the transducer, wherein the at least one microphone signal includes a reference microphone signal generated from an output of the reference microphone and an error microphone signal generated from an output of the error microphone indicative of an acoustic output of the transducer and the ambient audio sounds at the transducer, wherein adaptively generating generates the anti-noise signal from the reference microphone signal and an error signal indicative of the acoustic output of the transducer and the ambient sounds, wherein the method further comprises:
shaping the source audio with a secondary path response provided by a secondary path adaptive filter; and
removing the shaped source audio from the error microphone signal to generate the error signal.

23. The method of claim 22, wherein the detecting detects the frequency-dependent characteristic of the reference microphone signal.

24. The method of claim 22, wherein the detecting detects the frequency-dependent characteristic of the error microphone signal.

25. The method of claim 22, further comprising shaping inputs to a coefficient control block of the adaptive filter with a non-adaptive filter having a fixed response, so that sensitivity of the adaptation of the adaptive filter is altered at one or more frequencies or in one or more frequency bands by the fixed response, and wherein the altering alters the adaptation of the adaptive filter by altering the fixed response of the non-adaptive filter.

26. The method of claim 25, further comprising selecting the fixed response from among multiple predetermined frequency responses in conformity with a result of detecting the frequency-dependent characteristic of the at least one microphone signal.

27. The method of claim 20, wherein the detecting detects the frequency-dependent characteristic of one or both of the reference microphone signal and the error microphone signal.

28. The method of claim 27, wherein the detecting detects the frequency-dependent characteristic of both of the reference microphone signal and the error microphone signal, and wherein the method further comprises determining a direction of ambient audio sounds causing the frequency-dependent characteristic, and wherein the altering alters the adaptation of the adaptive filter selectively in conformity with the determined direction of the ambient audio sounds.

29. The method of claim 20, wherein the at least one microphone includes a near-speech microphone mounted on the housing for providing a near-speech microphone signal indicative of speech of the listener and the ambient audio sounds, and wherein the detecting detects the frequency-dependent characteristic of the near-speech microphone signal.

30. The method of claim 20, wherein the detecting detects the frequency-dependent characteristic of the at least one microphone signal by measuring an amplitude of one or more frequencies or frequency bands of the at least one microphone signal.

31. The method of claim 30, further comprising selecting the one or more frequencies or frequency bands from among multiple predetermined frequencies or frequency bands.

32. The method of claim 30, further comprising:
connecting an external headset to the personal audio device;
detecting a type of the external headset; and
selecting the one or more frequencies or frequency bands in conformity with the detected type of the external headset.

33. The method of claim 20, wherein the halting halts adaptation of the adaptive filter in response to detecting the frequency-dependent characteristic of the at least one microphone signal.

34. The method of claim 20, wherein the detecting detects whether low-frequency content is present.

35. The method of claim 20, wherein the detecting detects whether high-frequency content is present.

36. The method of claim 20, wherein the altering alters a rate of update of a coefficient control block of the adaptive filter.

37. The method of claim 20, further comprising:
controlling a variable portion of a frequency response of the adaptive filter with a leakage characteristic that restores the response of the adaptive filter to a predetermined response at a particular rate of change; and
altering the particular rate of change in conformity with a result of the detection of the frequency-dependent characteristic.

38. The method of claim 20, wherein the altering alters adaptation of the response of the adaptive filter by altering a characteristic of a signal injected to shape a response of the adaptive filter.

39. An integrated circuit for implementing at least a portion of a personal audio device, comprising:
an output for providing an output signal to an output transducer including both source audio for playback to a listener and an anti-noise signal for countering the effects of ambient audio sounds in an acoustic output of the transducer;
at least one microphone input for receiving at least one microphone signal indicative of the ambient audio sounds; and
a processing circuit that adaptively generates the anti-noise signal to reduce the presence of the ambient audio sounds heard by the listener in conformity with the at least one microphone signal using an adaptive filter, wherein the processing circuit detects a frequency-dependent characteristic of one of the at least one microphone signal and alters adaptation of the adaptive filter in conformity with a result of the detection of the frequency-dependent characteristic.

40. The integrated circuit of claim 39, wherein the at least one microphone signal includes a reference microphone signal indicative of the ambient audio sounds, wherein the processing circuit generates the anti-noise signal from the reference microphone signal by providing the reference microphone signal to an input of the adaptive filter, and wherein the processing circuit detects the frequency-dependent characteristic of the reference microphone signal.

41. The integrated circuit of claim 39, wherein the at least one microphone signal includes a reference microphone signal indicative of the ambient audio sounds and an error microphone signal indicative of the ambient audio sounds and an acoustic output of the transducer, wherein the processing circuit generates the anti-noise signal from the reference microphone signal by providing the reference microphone signal to an input of the adaptive filter, wherein the processing circuit further implements a secondary path filter having a secondary path response that shapes the source audio and a combiner that removes the source audio from the error microphone signal to provide an error signal indicative of the combined anti-noise and ambient audio sounds delivered to the listener, and wherein the adaptive filter generates the anti-noise signal in conformity with the error signal and the reference microphone signal.

42. The integrated circuit of claim 41, wherein the processing circuit detects the frequency-dependent characteristic of the reference microphone signal.

43. The integrated circuit of claim 41, wherein the processing circuit detects the frequency-dependent characteristic of the error microphone signal.

44. The integrated circuit of claim 41, wherein the processing circuit further implements a non-adaptive filter having a fixed response for shaping inputs to a coefficient control block of the adaptive filter, so that sensitivity of the adaptation of the adaptive filter is altered at one or more frequencies or in one or more frequency bands by the fixed response, and wherein the altering of the adaptation of the adaptive filter is performed by altering the fixed response of the non-adaptive filter.

45. The integrated circuit of claim 44, wherein the processing circuit selects the fixed response from among multiple predetermined frequency responses in conformity with a result of detecting the frequency-dependent characteristic of the at least one microphone signal.

46. The integrated circuit of claim 39, wherein the processing circuit detects the frequency-dependent characteristic of one or both of the reference microphone signal and the error microphone signal.

47. The integrated circuit of claim 46, wherein the processing circuit detects the frequency-dependent characteristic of both of the reference microphone signal and the error microphone signal and determines a direction of ambient audio sounds causing the frequency-dependent characteristic, and wherein the processing circuit alters adaptation of the adaptive filter selectively in conformity with the direction of the ambient audio sounds.

48. The integrated circuit of claim 39, wherein the at least one microphone signal includes a near-speech microphone signal indicative of speech of the listener and the ambient audio sounds, wherein the processing circuit detects the frequency-dependent characteristic of the near-speech microphone signal.

49. The integrated circuit of claim 39, wherein the processing circuit detects the frequency-dependent characteristic of the at least one microphone signal by measuring an amplitude of one or more frequencies or frequency bands of the at least one microphone signal.

50. The integrated circuit of claim 49, wherein the one or more frequencies or frequency bands are selectable.

51. The integrated circuit of claim 49, further comprising a headset type detection circuit for detecting a type of an external headset coupled to the output, and wherein the processing circuit selects the one or more frequencies or frequency bands in conformity with the detected type of the external headset.

52. The integrated circuit of claim 39, wherein the processing circuit halts adaptation of the adaptive filter in response to detecting the frequency-dependent characteristic of the at least one microphone signal.

53. The integrated circuit of claim 39, wherein the detecting detects whether low-frequency content is present.

54. The integrated circuit of claim 39, wherein the detecting detects whether high-frequency content is present.

55. The integrated circuit of claim 39, wherein the altering alters a rate of update of a coefficient control block of the adaptive filter.

56. The integrated circuit of claim 39, wherein the processing circuit controls a variable portion of a frequency response of the adaptive filter with a leakage characteristic that restores the response of the adaptive filter to a predetermined response at a particular rate of change, and wherein the processing circuit alters the particular rate of change in conformity with a result of the detection of the frequency-dependent characteristic.

57. The integrated circuit of claim 39, wherein the processing circuit alters adaptation of the response of the adaptive filter by altering a characteristic of a signal injected to shape a response of the adaptive filter.

58. A personal audio device, comprising:
a personal audio device housing;
a transducer mounted on the housing for reproducing an audio signal including both source audio for playback to a listener and an anti-noise signal for countering the effects of ambient audio sounds in an acoustic output of the transducer;
at least two microphones mounted on the housing for providing at least two microphone signals indicative of the ambient audio sounds; and
a processing circuit that generates the anti-noise signal to reduce the presence of the ambient audio sounds heard by the listener in conformity with at least one of the at least two microphone signals using an adaptive filter, wherein the processing circuit determines a direction of a detected ambient audio sound from the at least two microphone signals, and wherein the processing circuit alters adaptation of the adaptive filter selectively in conformity with the direction of the detected ambient audio sound.

59. The personal audio device of claim 58, wherein the processing circuit alters adaptation of the response of the adaptive filter by altering a characteristic of a signal injected to shape a response of the adaptive filter.

60. The personal audio device of claim 59, wherein the at least two microphone signals include a reference microphone that generates a reference microphone signal and an error microphone that generates an error microphone signal, wherein the processing circuit generates the anti-noise signal from the reference microphone signal by providing the reference microphone signal to an input of the adaptive filter, wherein the error microphone is mounted on the housing in proximity to the transducer so that the error microphone signal is indicative of the acoustic output of the transducer and the ambient audio sounds at the transducer, wherein the processing circuit further implements a secondary path filter having a secondary path response that shapes the source audio and a combiner that removes the source audio from the error microphone signal to provide an error signal indicative of the combined anti-noise and ambient audio sounds delivered to the listener, wherein the adaptive filter generates the anti-noise signal in conformity with the error signal and the reference microphone signal, and wherein the processing circuit determines that the detected ambient audio sound arrived at the error microphone less than a predetermined period of time after arriving at the reference microphone, and in response, alters adaptation of the adaptive filter to de-emphasize higher frequencies in the response of the adaptive filter.

61. The personal audio device of claim 58, wherein the processing circuit alters the adapting by weighting the contribution of each of the at least two microphones in conformity with the direction of the detected ambient sound.

62. The personal audio device of claim 61, wherein the weighting disables a contribution of at least one of the at least two microphones to the determining of the direction of the detected ambient sound.

63. A method of countering effects of ambient audio sounds by a personal audio device, the method comprising:
adaptively generating an anti-noise signal to reduce the presence of the ambient audio sounds heard by the listener in conformity with at least one of the at least two microphone signals using an adaptive filter;
combining the anti-noise signal with source audio;
providing a result of the combining to a transducer;
measuring the ambient audio sounds with at least two microphones that provide corresponding at least two microphone signals;
determining a direction of a detected ambient audio sound from the at least two microphone signals; and
altering adaptation of the adaptive filter selectively in conformity with the direction of the detected ambient audio sound.

64. The method of claim 63, wherein the altering alters adaptation of the response of the adaptive filter by altering a characteristic of a signal injected to shape a response of the adaptive filter.

65. The method of claim 64, wherein the at least one microphone includes a reference microphone for measuring the ambient audio sounds and an error microphone for measuring the ambient audio sounds and an acoustic output of the transducer, wherein the at least one microphone signal includes a reference microphone signal generated from an output of the reference microphone and an error microphone signal generated from an output of the error microphone indicative of an acoustic output of the transducer and the ambient audio sounds at the transducer, wherein adaptively generating generates the anti-noise signal from the reference microphone signal and an error signal indicative of the acoustic output of the transducer and the ambient sounds, wherein the method further comprises:
shaping the source audio with a secondary path response provided by a secondary path adaptive filter; and
removing the shaped source audio from the error microphone signal to generate the error signal, and wherein the determining determines that the detected ambient audio sound arrived at the error microphone less than a predetermined period of time after arriving at the reference microphone, and wherein altering alters adaptation of the adaptive filter to de-emphasize higher frequencies in the response of the adaptive filter.

66. The method of claim 63, wherein the altering alters the adapting by weighting the contribution of each of the at least two microphones in conformity with the direction of the detected ambient sound.

67. The method of claim 66, wherein the weighting disables a contribution of at least one of the at least two microphones to the determining of the direction of the detected ambient sound.

68. An integrated circuit for implementing at least a portion of a personal audio device, comprising:
an output for providing an output signal to an output transducer including both source audio for playback to a listener and an anti-noise signal for countering the effects of ambient audio sounds in an acoustic output of the transducer;
at least two microphone inputs for receiving at least two microphone signals indicative of the ambient audio sounds; and
a processing circuit that adaptively generates the anti-noise signal to reduce the presence of the ambient audio sounds heard by the listener in conformity with at least one of the at least two microphone signals using an adaptive filter, wherein the processing circuit determines a direction of a detected ambient audio sound from the at least two microphone signals, and wherein the processing circuit alters adaptation of the adaptive filter selectively in conformity with the direction of the detected ambient audio sound.

69. The integrated circuit of claim 68, wherein the processing circuit alters adaptation of the response of the adaptive filter by altering a characteristic of a signal injected to shape a response of the adaptive filter.

70. The integrated circuit of claim 69, wherein the at least two microphone inputs include a reference microphone input for receiving a reference microphone signal indicative of the ambient audio sounds and an error microphone input for receiving an error microphone signal indicative of the acoustic output of the transducer and the ambient audio sounds at the transducer, wherein the processing circuit generates the anti-noise signal from the reference microphone signal by providing the reference microphone signal to an input of the adaptive filter, wherein the processing circuit further implements a secondary path filter having a secondary path response that shapes the source audio and a combiner that removes the source audio from the error microphone signal to provide an error signal indicative of the combined anti-noise and ambient audio sounds delivered to the listener, wherein the adaptive filter generates the anti-noise signal in conformity with the error signal and the reference microphone signal, and wherein the processing circuit determines that the detected ambient audio sound arrived at the error microphone less than a predetermined period of time after arriving at the reference microphone, and in response, alters adaptation of the adaptive filter to de-emphasize higher frequencies in the response of the adaptive filter.

71. The integrated circuit of claim 68, wherein the processing circuit alters the adapting by weighting the contribution of each of the at least two microphones in conformity with the direction of the detected ambient sound.

72. The integrated circuit of claim 71, wherein the weighting disables a contribution of at least one of the at least two microphones to the determining of the direction of the detected ambient sound.
